(19) United States
(12) Patent Application Publication
(10) Pub. No.: US 2014/0074350 A1
(43) Pub. Date: Mar. 13, 2014

(54) METHOD AND APPARATUS FOR DIAGNOSING A CHASSIS FRAME STATE

(71) Applicant: GM GLOBAL TECHNOLOGY OPERATIONS LLC, DETROIT, MI (US)

(72) Inventors: Thomas DEGENSTEIN, Mainz (DE); Lazhar CHAARI, Gau-Odernheim (DE); Olaf SCHAEDLER, Aarbergen (DE)

(73) Assignee: GM GLOBAL TECHNOLOGY OPERATIONS LLC, DETROIT, MI (US)

(21) Appl. No.: 14/023,976

(22) Filed: Sep. 11, 2013

(30) Foreign Application Priority Data
Sep. 12, 2012 (DE) 10 2012 017 939.1

(51) Int. Cl. G01M 17/007

(52) U.S. Cl. CPC G01M 17/007
USPC 701/34.4

(57) ABSTRACT

A method is provided for diagnosing the chassis frame state of a motor vehicle, which includes, but is not limited to ascertaining at least one diagnostic variable and displaying this diagnostic variable. At least one ascertained and displayed diagnostic variable indicates a balance, track width and/or brake disk planarity state for a chassis frame of the motor vehicle; and/or is determined based on an in particular periodic asymmetry in a steering gear.

### CROSS-REFERENCE TO RELATED APPLICATION

This application claims priority to Patent Application No. 10 2012 017 939.1, filed Sep. 12, 2012, which is incorporated herein by reference in its entirety.

### TECHNICAL FIELD

The technical field relates to a method for diagnosing the chassis frame state of a motor vehicle, in particular of an automobile, as well as to a diagnostic and computer program product for implementing such a method.

### BACKGROUND

Unbalanced tires can lead to periodic vibrations while traveling on a flat road surface that may be quantified by a so-called SRS value (“smooth road shake”). For example, vibrations ranging from 10 to 30 Hz that can be felt in the steering wheel can arise between about 80 and 160 km/h. Similarly, periodic vibrations while braking can be caused by non-planar brake disks, in particular a varying brake disk wall thickness or impact on a brake disk.

Known from DE 10 2010 046 072 A1 is a method of compensating for such vibrations in an electrical power steering mechanism. This improves driving comfort, but reduces feedback to the driver about damage to the chassis frame, in particular unbalanced tires or non-planar brake disks.

The same applies correspondingly with respect to compensating for a track width misalignment: During a track width misalignment, the vehicle does not travel along a straight line on a flat road surface with the steering wheel in a neutral position, or driving straight ahead requires a steering angle. For example, this can be compensated by an electrical power steering mechanism, which also reduces feedback to the driver.

In view of the foregoing, at least one object is to improve the operation of a motor vehicle. In addition, other objects, desirable features and characteristics will become apparent from the subsequent summary and detailed description, and the appended claims, taken in conjunction with the accompanying drawings and this background.

### SUMMARY

A diagnostic variable is ascertained and displayed to indicate or quantitatively describe a balance state relative to the chassis frame of a motor vehicle. A chassis frame particular exhibit one or more wheels, a brake with one or more brake assemblies for braking these wheels, in particular with at least one brake disk and/or at least one brake caliper and/or actuator, and/or a steering gear, in particular with a steering wheel, steering linkage and/or a steering assistance system, in particular one that is electromotively, magnetically, hydraulically and/or pneumatically actuated. A balance state is here understood in particular to be a measure for a static and/or dynamic imbalance relative to one or more wheels, in particular steered and/or front axle wheels, of the chassis frame, for example a deviation by an axis of inertia from a rotational axis of a wheel or the like. Accordingly, a diagnostic variable that indicates a balance state for the chassis frame of a motor vehicle can encompass, especially be, in particular such a potentially converted or standardized measure for a static and/or dynamic imbalance of one or more wheels.

Additionally or alternatively to a diagnostic variable that indicates a balance state, a diagnostic variable that indicates or quantitatively describes a track width state of the chassis frame can be ascertained and displayed in one embodiment. Understood here in particular as a track width state is a measure for a parallelism or angle between a longitudinal alignment of one or more steered wheels, in particular front axle wheels, of the chassis frame relative to a steering mechanism position, especially a steering wheel position: Given a misaligned track width, a longitudinal alignment of the wheel(s) deviates from the steering wheel position, so that when the steering wheel is in the neutral or 0 position, the vehicle “pulls” to one side due to the deviating longitudinal alignment of the wheel(s). Accordingly, a diagnostic variable indicating the track width state for a chassis frame of the motor vehicle can encompass, especially be, in particular such a potentially converted or standardized measure for such a parallelism or such an angle.

Additionally or alternatively, a diagnostic variable indicating a track width state for the chassis frame of a motor vehicle can encompass, especially be, in particular a measure for a steering actuation, in particular a steering angle and/or a steering force, which must be imposed on the steering gear in particular by a driver and/or a steering assistance system in order to make the vehicle travel straight ahead. As a consequence, a track width state of the chassis frame in terms of one embodiment describe in particular a so-called pulling or sideways deviation of the vehicle with the steering when in a neutral or 0 position or an in particular constant steering actuation during straight ahead travel in order to compensate for a pulling, a diagnostic variable indicating a track width state for a chassis frame of the motor vehicle can encompass, especially be, in particular a measure for a pulling of the vehicle.

Additionally or alternatively, an embodiment can involve ascertaining and displaying a diagnostic variable that indicates or quantitatively describes a brake disk planarity state for the chassis frame of a motor vehicle. A brake disk planarity state is here understood in particular as a measure for a variation in wall thickness and/or an impact or imbalance affecting one or more brake disks of one or more wheels, in particular steered and/or front axle wheels, of the chassis frame. Accordingly, a diagnostic variable indicating a brake disk planarity state for the chassis frame of a motor vehicle can encompass, especially be, in particular such a potentially converted or standardized measure for such a variation in wall thickness and/or such an impact.

Because one or more diagnostic variables indicating a balance, track width and/or brake disk planarity state for a chassis frame of the motor vehicle can be ascertained and displayed in this embodiments, it advantageously becomes possible to diagnose and rectify an undesired balance, track width or brake disk planarity state, for example an excess imbalance for one or more wheels, a misaligned track width of the chassis frame, or an impact or excess fluctuation in a wall thickness of one or more brake disks, even if these states are at least partially compensated, and thus very difficult if not impossible for the driver to detect during operation.

In particular, an imbalance in one or more wheels of a steered axle of a motor vehicle can lead to a mostly periodic asymmetry in a steering gear, for example a torque acting in a steering linkage or on a steering wheel and/or steering assistance system, which varies, in particular at an SRS frequency that can range between approximately 10 and approximately 30 Hz. Similarly, a displaced track width and/or a brake disk non-planarity can result in such asymmetries, in particular periodic ones.

In another embodiment that can advantageously be combined with the aspect explained above, it is therefore generally proposed that a diagnostic variable be ascertained and displayed based on an in particular periodic asymmetry in a steering gear. However, both aspects do not have to be combined with each other. For example, a diagnostic variable that indicates a brake disk planarity state can also be ascertained based on an in particular periodic asymmetry in a reaction force, which due to a brake disk non-planarity acts on the brake, in particular a brake actuator and/or caliper. Similarly, an in particular periodic asymmetry in a steering gear can also be used as the basis for ascertaining and displaying a diagnostic variable that does not depend on a balance, track width and/or brake disk planarity state.

In particular a diagnostic variable indicating a balance state can be ascertained based on an SRS value, for example an acceleration, preferably standardized with a balance situated at a prescribed location, of a steering wheel, for example in the y-direction, e.g., measured in terms of steering wheel acceleration per weight unit of imbalance, for example in milli-g (g≈9.81 N/kg) per ounce [mg/ounce], and/or a vehicle speed. An SRS value usually rises with the vehicle speed given an identical imbalance on the one hand, and with the imbalance given an identical vehicle speed on the other. Accordingly, a correlation can be ascertained in one embodiment between the SRS value, vehicle speed and imbalance or balance state, in particular in advance and/or empirically or simulatively. This correlation can be stored, in particular in tabular form. A current balance state can be determined from the latter based on an ascertained current vehicle speed and ascertained current SRS value, and in turn be used to ascertain a diagnostic variable that depends (especially linearly) on the current balance state or indicates the latter, if necessary after conversion, in particular standardization or scaling. For example, a diagnostic variable indicating a brake disk planarity state can similarly also be ascertained based on a vehicle speed, since the frequency of an asymmetry caused by a variation in brake disk wall thickness depends on the vehicle speed.

As introductorily stated, an embodiment is especially advantageous if a chassis frame state upon which an ascertained and displayed diagnostic variable depends is at least partially compensated, for example as explained in the DE 10 2010 046 072 A1 mentioned at the outset, which will be referenced in its entirety, and whose disclosure contents, in particular with regard to balance state compensation, will be incorporated into the present disclosure. This is because, at least partially, compensating for a chassis frame state makes it harder in particular for the driver to recognize this state during operation, in particular at an early stage. On the other hand, chassis frame states, in particular a balance, track width and/or brake disk planarity state, for example an SRS value, which have to be provided for compensation anyway, can advantageously also be used for ascertaining and displaying diagnostic variables.

In particular to reduce the load on a transfer means for the motor vehicle, for example a bus, an embodiment can provide that one or more diagnostic variables only be transferred if any change therein exceeds a prescribed limit. In this way, an optimal compromise can be made between the load on the transfer device and up-to-date of the diagnostic variable(s).

In particular, an at least partially compensated balance, track width and/or brake disk planarity state is normally only of interest to experienced users. For this reason, an embodiment can generally provide that one or more diagnostic variables only be displayed in a diagnostic mode, in particular in a menu, preferably a submenu, of a motor vehicle information device, in particular a car computer. In a further development, this diagnostic mode can be activated by an operator and/or automatically, in particular automatically activated, if one or more diagnostic variables and/or any change(s) therein exceed a prescribed limit.

A diagnostic variable can in particular be discrete or continuous and/or linearly or nonlinearly depend on the state of the chassis frame of a motor vehicle. It can be displayed in conjunction with an evaluation in one embodiment. In particular, it can be displayed whether the diagnostic variable lies within a permissible or noncritical range, or requires that the chassis frame be inspected and/or the motor vehicle be turned off. One or more diagnostic variables can be displayed, in particular during vehicle operation and/or inside the motor vehicle, to allow the driver to arrive at a diagnosis and react accordingly while driving, and hence at an early stage, in particular also given at least partially compensated chassis frame states.

In one embodiment, a diagnostic device is set up to implement a method described above. In one embodiment, it can exhibit a determination device for ascertaining one or more diagnostic variables and a display device for displaying these diagnostic variable(s). The determination device is set up to ascertain at least one diagnostic variable indicating a balance, track width and/or brake disk planarity state for the chassis frame of the motor vehicle, and/or based on an in particular periodic asymmetry in a steering gear. The diagnostic device can have a digital microprocessor unit (CPU) data-linked with a storage system and bus system. The CPU is designed to execute commands configured as a program filed in a storage system, acquire input signals from the data bus, and release output signals to the data bus. The storage system can have various storage media, such as optical, magnetic, solid-state and other nonvolatile media. The program can be configured so as embody or be able to implement the methods described herein, so that the CPU can execute the steps comprising such methods, and thus control the device. In one embodiment, a computer program product exhibits a program code, which is stored on a computer-readable medium and, if necessary after compiling, implements a method described above when running in the computer.

### BRIEF DESCRIPTION OF THE DRAWINGS

The present invention will hereinafter be described in conjunction with the following drawing figures, wherein like numerals denote like elements, and:

FIG. 1 is a diagnostic device according to an embodiment; and

FIG. 2 is the sequence of a method according to an embodiment.

### DETAILED DESCRIPTION

The following detailed description is merely exemplary in nature and is not intended to limit application and uses. Furthermore, there is no intention to be bound by any theory presented in the preceding background or the following detailed description.

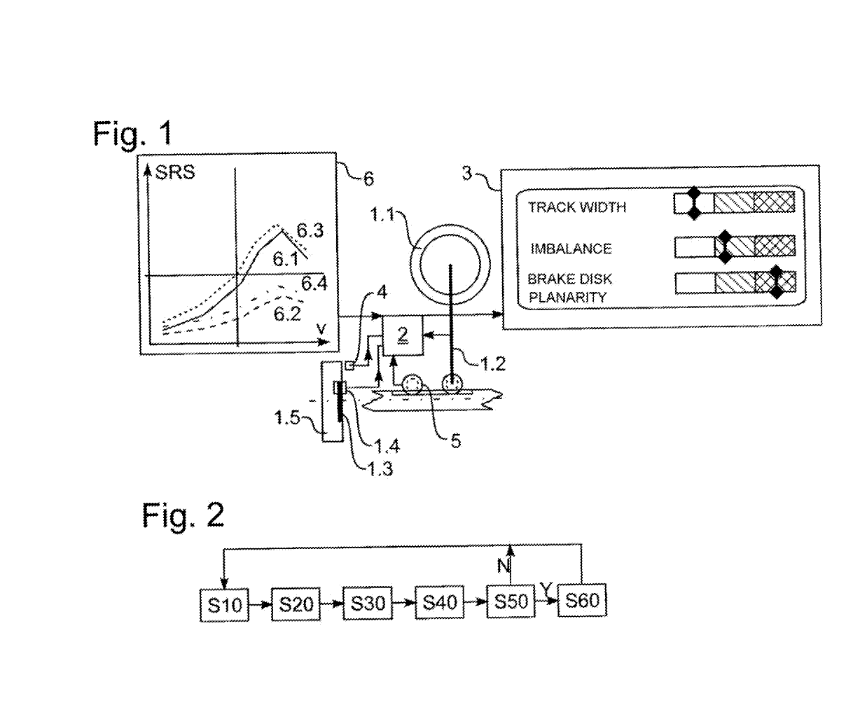

FIG. 1 shows part of a chassis frame of a passenger vehicle with a steering wheel 1.1, a steering linkage 1.2, a brake caliper 1.3 and a brake disk 1.4 of a wheel 1.5 and a steering assistance system 5 along with a wheel or vehicle speed sensor 4. In one embodiment, a diagnostic device includes, but is not limited to a determination device taking the form of a CPU 2 with a storage system 6, which is signal-linked with the steering linkage 1.2, a force or pressure sensor on the brake caliper 1.3, the wheel or vehicle speed sensor 4 and the steering assistance system 5, and receives signals from the latter via a data bus. The diagnostic device further exhibits a display device in the form of a display of a car computer 3, FIG. 1 depicts a diagnostic mode that the driver activated by selecting a corresponding menu.

In one embodiment, a method implemented with the diagnostic device is explained in particular with reference to FIG. 2. If a diagnostic mode is activated, the display of the car computer 3 shows a diagnostic variable indicating a track width state of the front, steered axle of the chassis frame (top of FIG. 1: “TRACK WIDTH”), a diagnostic variable indicating a balance state of this axle (middle of FIG. 1: “IMBALANCE”), and a diagnostic variable indicating a brake disk planarity state of this axle (bottom of FIG. 1: “BRAKE DISK PLANARITY”).

The diagnostic variables are each displayed as evaluated by positioning a slide on a scale divided into three fields, which are marked on FIG. 1 as blank, diagonally hatched or crosshatched, and rate the diagnostic variable as ‘noncritical’ (left or blank on FIG. 1), ‘to be monitored’ (middle or diagonally hatched on FIG. 1) or ‘critical’ (right or crosshatched on FIG. 1). In the constellation presented on FIG. 1, the diagnostic variable indicating a track width state of the chassis frame is rated as ‘noncritical’, the diagnostic variable indicating a balance state of the chassis frame as ‘to be monitored’, and the diagnostic variable indicating a brake disk planarity state as “critical”. This tells the driver that he or she should have the brake disks inspected.

Step S20 involves determining an SRS value, for example the acceleration of steering wheel 1.1, a torque periodically acting on the steering linkage 1.1 with an SRS frequency of between approximately 10 and approximately 30 Hz or an amplitude of a torque acting on the steering linkage 1.2 or its FFT, in particular in a prescribed frequency range. A vehicle speed v is determined in step S30 based on the signals of the sensor 4. Step S40 entails determining a diagnostic variable indicating a balance state of the chassis frame based on a stored correlation between the SRS value and vehicle speed. To this end, FIG. 1 exemplarily depicts the progression of an SRS value (ordinate on FIG. 1) over the vehicle speed v (abscissa on FIG. 1) for a first, smaller imbalance without compensation by the steering assistance system 5 (“6.1”—solid on FIG. 1), for the first imbalance with compensation by the steering assistance system 5 (“6.2”—dashed on FIG. 1), for a second, larger imbalance without compensation by the steering assistance system 5 (“6.3”—dotted on FIG. 1), and for the second imbalance with compensation by the steering assistance system 5 (“6.4”—dash and dotted on FIG. 1). As denoted on FIG. 1, the ascertained vehicle speed v and ascertained SRS value are used in step S40 to determine the second, larger imbalance as the current diagnostic variable.

In step S50, the CPU 2 checks whether the change in this diagnostic variable exceeds a prescribed limit (S50: “Y”) or not (S50: “N”). Should this not be the case, the method returns to step S10, without the current diagnostic variable being transferred. If the change exceeds the prescribed limit, it is transferred in step S60 to the display of the car computer 3, the method subsequently returns to step S10, so that the display of the car computer 3 now displays the updated diagnostic variable on the scale, which depends on the balance state and displays the latter.

Only the process of acquiring and updating the display of the diagnostic variable indicating the balance state of the chassis frame was described above based on FIG. 2. In parallel, sequentially or alternatively hereto, the diagnostic variable indicating a track width and/or brake disk planarity state for the chassis frame of the motor vehicle can be displayed as ascertained and updated in the same way. For example, the amplitudes of vibrations that arise while braking is used as the diagnostic variable indicating a brake disk planarity state instead of steps S20 to S40.

Even though exemplary embodiments were described in the preceding specification, let it be noted that a plurality of modifications are possible. Let it also be noted that the exemplary embodiments only represent examples that are not intended to limit the applications and structural design in any way. Rather, the preceding specification provides the expert with a guide for realizing at least one exemplary embodiment. Various changes, in particular with respect to the function and arrangement of the described constituents, can be introduced without departing from the scope of protection as outlined in the claims and the feature combinations equivalent thereto.

1. A method for diagnosing a chassis frame state of a motor vehicle, comprising:
ascertaining a diagnostic variable; and
displaying the diagnostic variable;
wherein the diagnostic variable indicates a parameter for a chassis frame of the motor vehicle, and
wherein the diagnostic variable is determined based at least in part on periodic asymmetry in a steering gear.

2. The method according to claim 1, wherein the diagnostic variable is determined based at least in part on an SRS value.

3. The method according to claim 1, wherein a state of the chassis frame on which the diagnostic variable at least partially depends is an at least partially compensated diagnostic variable.

4. The method according to claim 1, wherein the diagnostic variable is transferred if a change therein exceeds a prescribed limit.

5. The method according to claim 1, wherein the diagnostic variable is displayed in an activatable diagnostic mode.

6. The method according to claim 1, wherein the diagnostic variable is displayed as an evaluated diagnostic variable.

7. The method according to claim 1, wherein the diagnostic variable is displayed during vehicle operation.

8. A diagnostic device for diagnosing a chassis frame state of a motor vehicle, comprising:
a determination device that is configured to ascertain diagnostic variable indicating a parameter for a chassis frame of the motor vehicle based at least in part on a periodic asymmetry in a steering gear; and
a display device that is configured to display the diagnostic variable.

9. (canceled)

10. The method according to claim 1, wherein the parameter is balance.

11. The method according to claim 1, wherein the parameter is track width.

12. The method according to claim 1, wherein the parameter is a brake disk planarity state.

13. The method according to claim 1, wherein the diagnostic variable is determined based at least in part on a vehicle speed.

14. The diagnostic device according to claim 8, wherein the diagnostic variable is displayed inside the motor vehicle.

15. The diagnostic device according to claim 8, wherein the parameter is balance.

16. The diagnostic device according to claim 8, wherein the parameter is track width.

17. The diagnostic device according to claim 8, wherein the parameter is a brake disk planarity state.

18. The diagnostic device according to claim 8, wherein the diagnostic variable is determined based at least in part on an SRS value.

19. The diagnostic device according to claim 8, wherein a state of the chassis frame on which the diagnostic variable at least partially depends is an at least partially compensated diagnostic variable.

20. The diagnostic device according to claim 8, wherein the diagnostic variable is transferred if a change therein exceeds a prescribed limit.

21. The diagnostic device according to claim 8, wherein the diagnostic variable is displayed in an activatable diagnostic mode.
